(19) United States
(12) Patent Application Publication
(10) Pub. No.: US 2025/0380158 A1
(43) Pub. Date: Dec. 11, 2025

(54) DATA PREPARATION FOR AI/ML MODEL TRAINING IN CELLULAR SYSTEMS

(71) Applicant: Samsung Electronics Co., Ltd., Suwon-si (KR)

(72) Inventors: Tiexing Wang, Melissa, TX (US); Yang Li, Plano, TX (US)

(21) Appl. No.: 19/015,491

(22) Filed: Jan. 9, 2025

Related U.S. Application Data
(60) Provisional application No. 63/658,649, filed on Jun. 11, 2024.

(51) Int. Cl. H04W 24/02; H04L 41/16

(52) U.S. Cl. CPC H04W 24/02; H04L 41/16

(57) ABSTRACT

Apparatuses and methods of data preparation for artificial intelligence (AI)/machine learning (ML) model training in cellular systems. A method includes receiving, by a network device, user equipment (UE) data from a UE and base station (BS) data from a BS; segmenting, based on a condition, the UE data and the BS data into a plurality of UE data segments and a plurality of BS data segments, respectively; identifying a common metric used in both a UE data segment of the plurality of UE data segments and a BS data segment of the plurality of BS data segments; and aligning the UE data segment with the BS data segments in time domain based on the common metric.

### CROSS-REFERENCE TO RELATED APPLICATION AND CLAIM OF PRIORITY

The present application claims priority under 35 U.S.C. § 119 (e) to U.S. Provisional Patent Application No. 63/658,649 filed on Jun. 11, 2024, which is hereby incorporated by reference in its entirety.

### TECHNICAL FIELD

This disclosure relates generally to wireless networks. More specifically, this disclosure relates to data preparation for artificial intelligence (AI)/machine learning (ML) model training in cellular systems.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for data preparation for AI/ML model training in cellular systems.

In one embodiment, a method of preparing data is provided. The method includes: receiving, by a network device, user equipment (UE) data from a UE and base station (BS) data from a BS; segmenting, based on a condition, the UE data and the BS data into a plurality of UE data segments and a plurality of BS data segments, respectively; identifying a common metric used in both a UE data segment of the plurality of UE data segments and a BS data segment of the plurality of BS data segments; and aligning the UE data segment with the BS data segment in time domain based on the common metric.

In another embodiment, a network device is provided. The network device includes a memory configured to receive UE data from a UE and BS data from a BS; and a processor operably coupled to the memory. The network device, when executed by the processor, is configured to: segment, based on a condition, the UE data and the BS data into a plurality of UE data segments and a plurality of BS data segments, respectively; identify a common metric used in both a UE data segment of the plurality of UE data segments and a BS data segment of the plurality of BS data segments; and align the UE data segment with the BS data segment in time domain based on the common metric.

In yet another embodiment, a non-transitory computer readable medium embodying a computer program is provided. The computer program includes program code that, when executed by a processor of a network device, causes the network device to: receive UE data from a UE and BS data from a BS; segment, based on a condition, the UE data and the BS data into a plurality of UE data segments and a plurality of BS data segments, respectively; identify a common metric used in both a UE data segment of the plurality of UE data segments and a BS data segment of the plurality of BS data segments; and align the UE data segment with the BS data segment in time domain based on the common metric.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example network device according to embodiment of the present disclosure;

FIG. 5 illustrates example antenna blocks or arrays according to embodiments of the present disclosure;

FIG. 6 illustrates an example block diagram of a data preparation method according to embodiments of the present disclosure;

FIG. 7 illustrates an example accelerated data alignment according to embodiments of the present disclosure; and

FIG. 8 illustrates an example flow chart for a data preparation method according to embodiments of the present disclosure.

### DETAILED DESCRIPTION

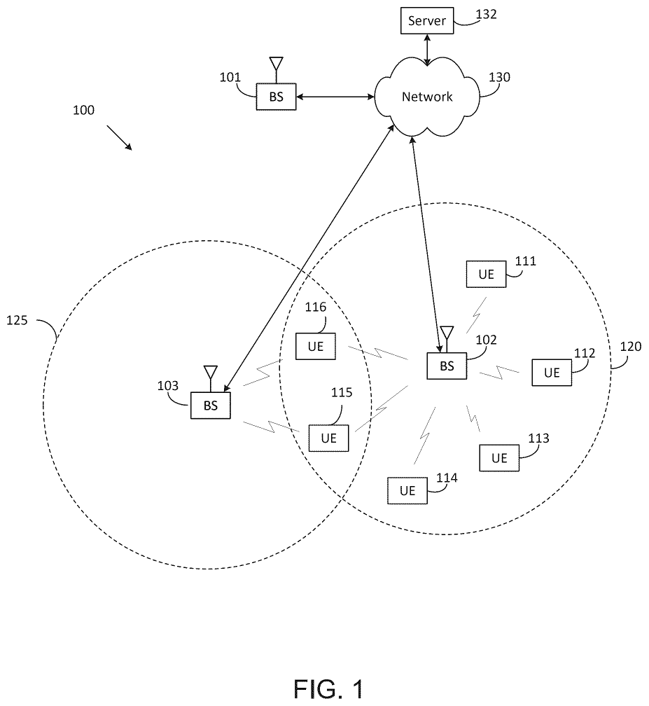

FIGS. 1 through 8, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

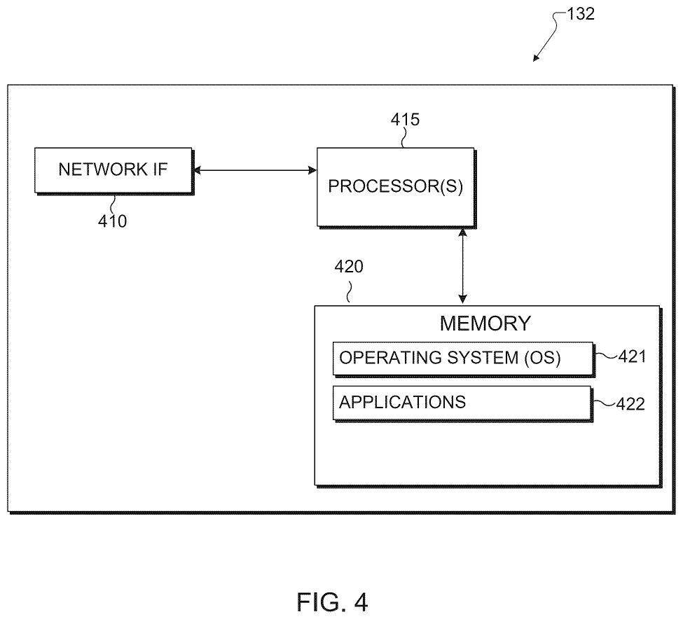

The wireless network 100 may be an AI/ML-based cellular system. As such, the at least one network 130 may be operably coupled to an electronic device (e.g., without limitation, a network server) 132 configured to, for example and without limitation, receive data from the gNBs 101-103 via backhaul/network interfaces and perform offline training of an AI/ML model (stored locally or remote). The data may include gNB data and UE data including logs and labels. The server 132 may represent one or more servers, and each server 132 includes a suitable computing or processing device for preparing the data for offline training of the AI/ML model. Each server 132 could, for example, include one or more processing devices, one or more memories storing instructions and data, and one or more network interfaces to receive the data and prepare the data for offline training of the AI/ML model as discussed further in detail with reference to FIG. 4. The AI/ML model is then trained offline based on the data prepared by the server 132 and deployed to enhance, e.g., without limitation, the functionality, efficiency, and adaptability of wireless communications among the electronic devices such as the gNBs 101-103, the UEs 111-116 and/or the network server 132.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support data preparation for AI/ML model training in cellular systems. In certain embodiments, one or more of the gNBs 101-103 include circuitry, programing, or a combination thereof, to utilize data preparation for AI/ML model training in cellular systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

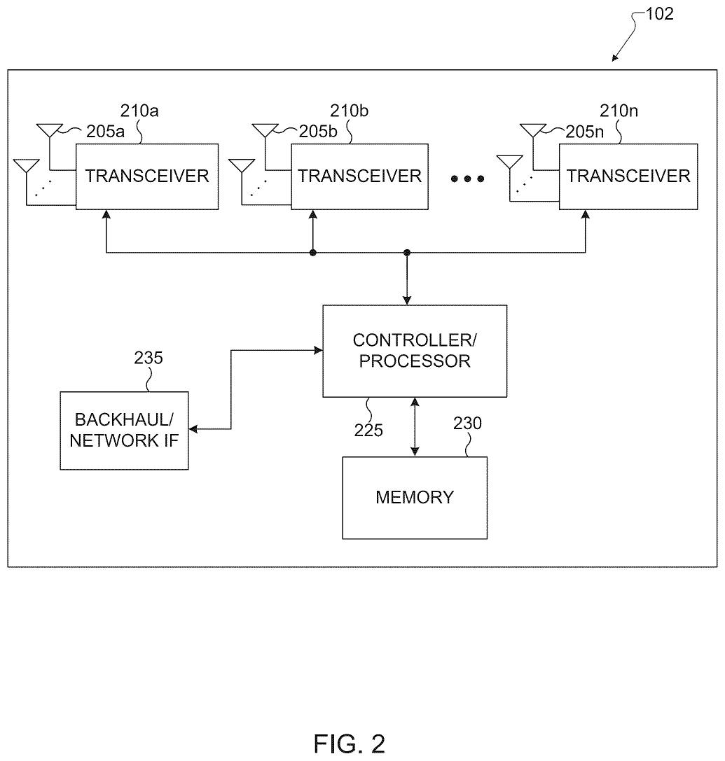

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support data preparation for offline training of an AI/ML model for use in cellular systems as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

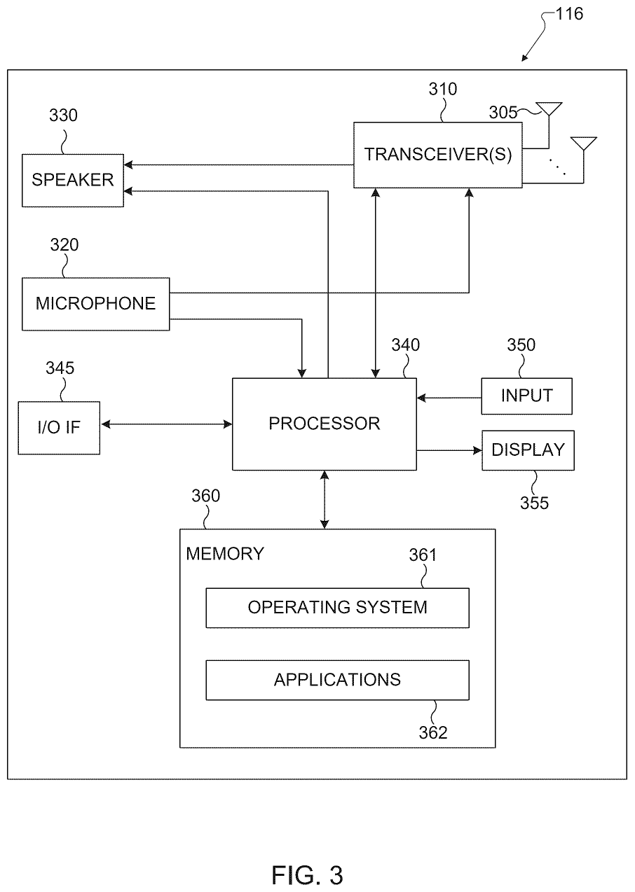

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to provide data for offline training of an AI/ML model for use in cellular systems as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

FIG. 4 illustrates an example network server 132 according to embodiments of the present disclosure. The embodiment of the server 132 illustrated in FIG. 4 is for illustration only. Different embodiments of servers 132 could be used without departing from the scope of this disclosure.

The server 132 may be a computing device including at least a network interface 410, a processor 415 and a memory 420. The network interface 410 may support communications over any suitable wired or wireless connection(s). It may include any suitable structure supporting communications over a wired or wireless connection, such as an Ethernet or transceiver. The network interface 410 may be, for example and without limitation, network interface cards (NICs) or network ports. The server 132 may receive data from the gNBs 101-103 via the network interface 410 and the UEs 111-116 via the gNBs 101-103. For example, the server 132 may receive data including gNB and UE logs and labels from the gNBs 101-103.

The processor 415 is coupled to the network interface 410 and can include one or more processors or other processing devices. The processor 415 can execute instructions that are stored in the memory 420, such as the OS 421 in order to control the overall operation of the server 132. The processor 415 can include any suitable number(s) and type(s) of processors or other devices in any suitable arrangement. For example, in certain embodiments, the processor 415 includes at least one microprocessor or microcontroller. Example types of processor 415 include microprocessors, microcontrollers, digital signal processors, field programmable gate arrays, application specific integrated circuits, and discrete circuitry. In certain embodiments, the processor 415 can include a neural network such as the AI/ML model as well as a CPU, a GPU or a tensor processing unit (TPU) that provides significant computational resources required for training the AI/ML model.

The processor 415 is also capable of executing other processes and programs resident in the memory 420, such as operations that receive and store data. As described in greater detail below, the processor 415 may execute processes to perform data preparation for offline training of the AI/ML model based on the data received from the gNBs 101-103 and the UEs 111-116. The processor 415 can move data into or out of the memory 420 as required by an executing process. In certain embodiments, the processor 415 is configured to execute the one or more applications 422 based on the OS 421 or in response to signals received from external source(s) or an operator. Example applications 422 can include an AI training application for the AI/ML model, if located within the server 132.

The memory 420 is coupled to the processor 415. Part of the memory 420 could include a RAM, and another part of the memory 420 could include a Flash memory or other ROM. The memory 420 can include persistent storage (not shown) that represents any structure(s) capable of storing and facilitating retrieval of information (such as data, program code, and/or other suitable information). For example, the storage may include data prepared for offline training of the AI/ML model. The memory 420 can contain one or more components or devices supporting longer-term storage of data, such as a read only memory, hard drive, Flash memory, or optical disc.

Although FIG. 4 illustrates one example of the server 132, various changes can be made to FIG. 4. For example, various components in FIG. 4 can be combined, further subdivided, or omitted and additional components can be added according to particular needs. As a particular example, the processor 415 can be divided into multiple processors, such as one or more central processing units (CPUs), one or more graphics processing units (GPUs), one or more neural networks, and the like.

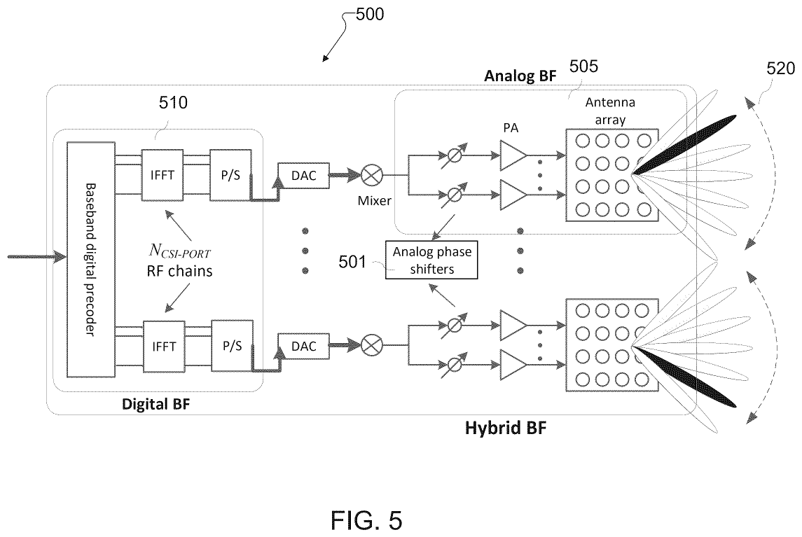

FIG. 5 illustrates example antenna blocks or arrays 500 according to embodiments of the present disclosure. The embodiment of the antenna blocks or arrays 500 illustrated in FIG. 5 is for illustration only. Different embodiments of antenna blocks or arrays 500 could be used without departing from the scope of this disclosure.

A unit for downlink (DL) signaling or for uplink (UL) signaling on a cell is referred to as a slot and may include one or more symbols. A bandwidth (BW) unit is referred to as a resource block (RB). One RB includes a number of sub-carriers (SCs). For example, a slot may have duration of one millisecond and an RB may have a bandwidth of 180 kHz and include 12 SCs with inter-SC spacing of 15 KHz. A slot may be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH may be transmitted over a variable number of slot symbols including one slot symbol. A UE may be indicated a spatial setting for a PDCCH reception based on a configuration of a value for a transmission configuration indication state (TCI state) of a control resource set (CORESET) where the UE receives the PDCCH. The UE may be indicated by a spatial setting for a PDSCH reception based on a configuration by higher layers or based on activation or indication by MAC CE or based on an indication by a DCI format scheduling the PDSCH reception of a value for a TCI state. The gNB may configure the UE to receive signals on a cell within a DL bandwidth part (BWP) of the cell DL BW.

A gNB (such as BS 103 of FIG. 1) transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources. A UE (such as UE 116 of FIG. 1) may determine CSI-RS transmission parameters through DL control signaling or higher layer signaling, such as an RRC signaling from a gNB. Transmission instances of a CSI-RS may be indicated by DL control signaling or configured by higher layer signaling. A DMRS is transmitted only in the BW of a respective PDCCH or PDSCH and a UE may use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH may be transmitted over a variable number of slot symbols including one slot symbol. The gNB may configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information may be configured to be with a smaller granularity than per TB and may be per data code block (CB) or per group of data CBs where a data TB includes a number of data.

A CSI report from a UE may include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB may use a DMRS to demodulate information in a respective PUSCH or PUCCH. SRS is transmitted by a UE to provide a gNB with an UL CSI and, for a TDD system, an SRS transmission may also provide a PMI for DL transmission. Additionally, in order to establish synchronization or an initial higher layer connection with a gNB, a UE may transmit a physical random-access channel (PRACH).

Each of these discussed transmitted, received, and/or calculated parameters or metrics are examples of data that is generated at the base station and/or UE that may be utilized in the data preparation for AI/ML model training in cellular systems in various embodiments of the present disclosure.

Although FIG. 5 illustrates one example antenna blocks or arrays 500, various changes may be made to FIG. 5. For example, various components in FIG. 5 could be combined, further subdivided, or omitted and additional components could be added according to particular needs.

In modern wireless systems, such as those described regarding FIGS. 1-5, an AI/ML model may be utilized for efficient operations of the wireless systems. The AI/ML model may be trained offline, but require a large amount of data for the offline training. The data may be collected from a UE(s) and/or BS(s), and the AI/ML model may use metrics recorded at the UE and/or BS side. In some circumstances, the metrics may be available at the BS side only, but some of the metrics may not be logged. In other circumstances, some metrics may be available at the UE side only, and the AI/ML model may need to predict the values of the metrics. In many circumstances, however, the data (including labels) may come from both the UE and BS sides. In those circumstances, it may be necessary to prepare the data for training the AI/ML model. For example, it may be necessary to align the data and labels where the clocks at the UE and BS sides are not perfectly aligned. The present disclosure describes methods of data preparation for offline training of an AI/ML model in wireless modules or systems.

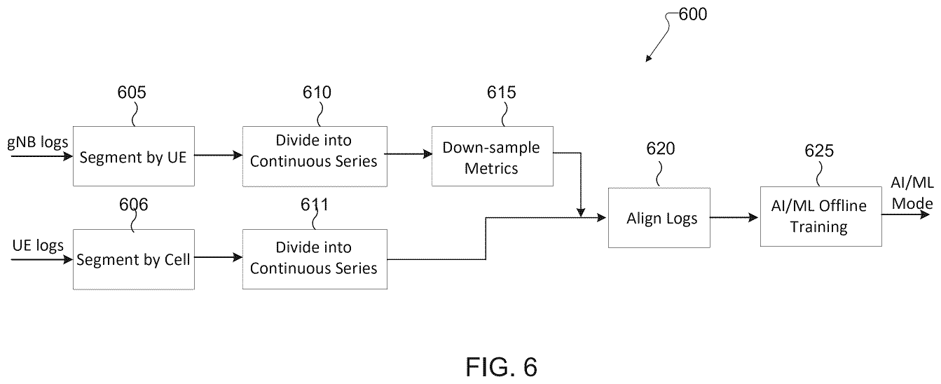

FIG. 6 illustrates an example block diagram for a data preparation method 600 according to embodiments of the present disclosure. The embodiment of the data preparation method in FIG. 6 is for illustration only. Other embodiments of a data preparation method for AI/ML model training be used without departing from the scope of this disclosure.

In the example of FIG. 6, the data preparation method 600 may be performed by a network device (such as a server 132 of FIGS. 1 and 4). As illustrated in the example of FIG. 6, the method 600 includes dividing metrics in UE and gNB logs into segments, aligning the segments at the UE and the gNB by metrics available at both sides and performing offline training of AI/ML models based on the aligned segments.

In the example of FIG. 6, the method 600 begins at steps 605 and 606. At step 605, the network device divides UE logs into multiple segments such that each segment corresponds to a single gNB or cell and is continuous based on a condition. At step 606, the network device divides gNB logs into multiple segments such that each segment corresponds to a single UE and is continuous based on a condition. Thus, the network device divides both the UE logs and the gNB logs into segments (also referred to herein as data segments or log segments) such that each segment corresponds to data of a single UE in a single cell. Metrics in each segment is then ordered by time. In one embodiment, the internal system time (e.g., transmission time interval (TTI) counter) is used for ordering metrics. In another embodiment, the GPS time is used for ordering metrics. Every segment of the UE logs and gNB logs satisfies one or more of the following conditions: (1) the largest time gap between two consecutive occurrences of a metric of interest (also referred to herein as a common metric or an alignment metric) in the same segment is smaller than a threshold; (2) the time duration of each segment is larger than a threshold; and (3) the smallest time gap between two occurrences of a metric of interest from different segments is larger than a threshold.

At steps 610 and 611, the network device divides each of UE log segments and gNB log segments, respectively, into continuous time series sub-segments. That is, since it is possible that some instances may not be stored in the logs for certain reasons, the network device may further divide both the UE and gNB log segments in a single cell into sub-segments such that each sub-segment may be considered as a continuous time series. In one embodiment, each segment may be divided into sub-segments such that: (1) the length of each sub-segment is greater than a threshold; (2) in each sub-segment, the time difference between two adjacent occurrences of a metric of interest is less than a threshold; and (3) the time difference of a metric of interest from different sub-segments is greater than a threshold. For instance, if a CSI feedback report is the metric of interest and the CSI feedback periodicity is 80 ms, then the maximum time difference between two CSI feedback reports in a sub-segment may not be greater than a threshold that is greater than 80 ms. In another embodiment, a sub-segment may be part of a segment such that: (1) the length of each sub-segment is greater than a threshold; (2) the time difference between two adjacent occurrences of any metric is less than a threshold; and (3) the time difference between two adjacent occurrences of any metric is larger than a threshold.

Optionally, at step 615 a metric of interest may be down-sampled according to its periodicity such that no duplicate value of metrics of interest exists in the segments to be aligned. In some embodiments, a metric of interest may be frequently used, but infrequently updated. For instance, an RI (rank indicator) may be used for DL transmission in every DL slot while it is typically updated every 80 ms. As such, it is possible that an RI is logged much more frequently (e.g., without limitation, every DL slot) than its periodicity (80 ms). In such instance, the RI may be down-sampled according to its periodicity for alignment.

At step 620, the network device aligns the UE log and the gNB log. For this alignment, the network device may first select sub-sequences of metrics existing in both UE and gNB sub-segments. In one embodiment, a sub-sequence containing information transmitted from a gNB to a UE may be used for alignment. In another embodiment, a sub-sequence containing information transmitted from a UE to a gNB may be used for alignment. The sub-sequence of metrics used for alignment may be from either data channel or control channel, and includes: DL metrics such as modulation-and-code scheme (MCS), layer, ACK/NACK, DL control information (DCI), medium access control (MAC) control element (CE), a signaling message including, but not limited to, radio resource control (RRC); and Uplink (UL) metrics such as MCS, layer, ACK/NACK, CSI feedback including channel quality indicator (CQI), precoding matrix index (PMI) or RI, reference signal received power (RSRP) and so forth.

In one embodiment, where accurate timing is required, a common metric with a small periodicity (for example and without limitation, MCS and ACK/NACK information) may be selected to achieve a TTI level alignment. Data aligned at the TTI level may be used for training the AI/ML model for TTI level operations in commercial systems. In another embodiment, a common metric with a larger periodicity, for example and without limitation, CQI and PMI, may be selected to achieve coarse alignment. The coarsely aligned data may be used for training the AI/ML model for infrequent operations in the commercial systems. As such, alignment metrics may be selected in accordance with requirements of a given application.

In one embodiment, numeric metric sequences may be used for alignment. As discussed below in greater detail, when a numeric metric is used for alignment, a pair of sub-segments of UE and gNB logs are aligned if one or more following conditions are satisfied: (1) the correlation of the alignment metric between the two sub-segments exceeds a threshold; or (2) the mean squared error (MSE) of the alignment metric between the two sub-segments is lower than a threshold. In another embodiment, non-numeric metric sequences may be used for alignment. For example, if the application is concerned only about whether an event happens in the network, non-numeric metrics (e.g., without limitation, an RRC configuration message) may be used for alignment. When a non-numeric metric is used for alignment, a pair of sub-segments of the UE and gNB logs are aligned if the sequences of the alignment metric at both segments are identical. In one embodiment, non-numerical sequences in the gNB and UE logs may be directly compared. In another embodiment, non-numerical sequences may be first converted into numerical representations, and the numerical representation may be then compared for alignment. In one embodiment, if the time duration of sub-segments is smaller than a threshold, the sub-segments may be removed from the aligned UE and gNB logs. In one embodiment, if the time duration of the corresponding segments of the UE and the gNB are similar, the segments of the UE and the gNB are also aligned.

Upon selecting alignment metrics, sequences consisting of the selected metrics available in both the UE and gNB logs may be checked for alignment. If two sequences from the UE and the gNB are matched, the corresponding sub-segments (or a subset of the sub-segments) are aligned.

In one embodiment, the cross correlation between two sequences of the selected metric from both the UE and the gNB may be used for alignment. The two sequences of the selected metric in the p-th and q-th sub-segment at the UE side and the gNB side may be defined as

$${s}_{ue}^{( p )} and {s}_{gNB}^{( q )} ,$$

respectively. Without loss of generality, assume that

$${s}_{ue}^{( p )} and {s}_{gNB}^{( q )}$$

are of length

$${L}_{ue}^{( p )} and {L}_{gNB}^{( q )} ,$$

respectively. The sub-sequence starting at the n₁-th and n₂-th entry with length L may be denoted by

$${s}_{ue}^{( p )} [ {n}_{1} : {n}_{1} + L - 1 ] and {s}_{gNB}^{( q )} [ {n}_{2} : {n}_{2} + L - 1 ] ,$$

respectively. The centered sub-sequence of

$${s}_{ue}^{( p )} [ {n}_{1} : {n}_{1} + L - 1 ] and {s}_{gNB}^{( q )} [ {n}_{2} : {n}_{2} + L - 1 ]$$

may be denoted as

$${\overline{s}}_{ue}^{( p )} [ {n}_{1} : {n}_{1} + L - 1 ] and {\overline{s}}_{gNB}^{( q )} [ {n}_{2} : {n}_{2} + L - 1 ] .$$

In one embodiment, the

$${s}_{ue}^{( p )} [ {n}_{1} : {n}_{1} + L - 1 ] and {s}_{gNB}^{( q )} [ {n}_{2} : {n}_{2} + L - 1 ]$$

may be centered by the average value of the sub-sequence, i.e.,

$${\overline{s}}_{ue}^{( p )} [ {n}_{1} : {n}_{1} + L - 1 ] = {s}_{ue}^{( p )} [ {n}_{1} : {n}_{1} + L - 1 ] - \frac{1}{L} {\sum }_{l = {n}_{1}}^{{n}_{1} + L - 1} {s}_{ue}^{( p )} [ l ] ,$$

$${\overline{s}}_{gNB}^{( q )} [ {n}_{2} : {n}_{2} + L - 1 ] = {s}_{gNB}^{( q )} [ {n}_{2} : {n}_{2} + L - 1 ] - \frac{1}{L} {\sum }_{l = {n}_{2}}^{{n}_{2} + L - 1} {s}_{gNB}^{( q )} [ l ] .$$

In another embodiment, the

$${s}_{ue}^{( p )} [ {n}_{1} : {n}_{1} + L - 1 ] and {s}_{gNB}^{( q )} [ {n}_{2} : {n}_{2} + L - 1 ]$$

may be centered by the average value of the entire sequence as follows:

$${\overline{s}}_{ue}^{( p )} [ {n}_{1} : {n}_{1} + L - 1 ] = {s}_{ue}^{( p )} [ {n}_{1} : {n}_{1} + L - 1 ] - \frac{1}{{L}_{ue}^{( p )}} {\sum }_{l = 1}^{{L}_{ue}^{( p )}} {s}_{ue}^{( p )} [ l ] ,$$

$${\overline{s}}_{gNB}^{( q )} [ {n}_{2} : {n}_{2} + L - 1 ] = {s}_{gNB}^{( q )} [ {n}_{2} : {n}_{2} + L - 1 ] - \frac{1}{{L}_{gNB}^{( q )}} {\sum }_{l = 1}^{{L}_{gNB}^{( q )}} {s}_{gNB}^{( q )} [ l ] .$$

The cross correlation ρ between

$${\overline{s}}_{ue}^{( p )} [ {n}_{1} : {n}_{1} + L - 1 ] and {\overline{s}}_{gNB}^{( q )} [ {n}_{2} : {n}_{2} + L - 1 ]$$

may be given as follows:

$$ρ [ p , q , {n}_{1} , {n}_{2} , L ] = \frac{< {\overline{s}}_{ue}^{( p )} [ {n}_{1} : {n}_{1} + L - 1 ] , {\overline{s}}_{gNB}^{( q )} [ {n}_{2} : {n}_{2} + L - 1 ] >}{{‖ {\overline{s}}_{ue}^{( p )} [ {n}_{1} : {n}_{1} + L - 1 ] ‖}_{2} {‖ {\overline{s}}_{gNB}^{( q )} [ {n}_{2} : {n}_{2} + L - 1 ] ‖}_{2}} \qquad Eq . ( 1 )$$

$$where L \leq min \{ {L}_{ue}^{( p )} - {n}_{1} , {L}_{gNB}^{( q )} - {n}_{2} \} is a parameter .$$

In another embodiment, the mean squared error (MSE) between the sequence of the selected metric from both the UE and the gNB may be used for alignment as follows:

$$MSE [ p , q , {n}_{1} , {n}_{2} , L ] = \frac{1}{L} {\sum }_{l = 1}^{L} {‖ {s}_{ue}^{( p )} [ {n}_{1} : {n}_{1} + L - 1 ] - {s}_{gNB}^{( q )} [ {n}_{2} : {n}_{2} + L - 1 ] ‖}_{2}^{2} \qquad Eq . ( 2 )$$

$$where L \leq min \{ {L}_{ue}^{( p )} - {n}_{1} , {L}_{gNB}^{( q )} - {n}_{2} \} is a parameter .$$

In one embodiment, L in Eqs. (1) and (2) may be a function of the periodicity of the selected metric. For instance, a small periodicity implies a large L. In another embodiment, L in Eqs. (1) and (2) may be a function of the total length of the sub-segment. For instance, a large sub-segment implies a large L. In another embodiment, L in Eqs. (1) and (2) may be a function of the computational resource available for the data preparation. For instance, a large computational resource implies a large L. In another embodiment, L in Eqs. (1) and (2) may be a function of the expected reliability of the alignment. For instance, a higher expectation on the reliability implies a larger L. In another embodiment, L in Eqs. (1) and (2) may be determined by a combination of the aforementioned factors.

In one embodiment, the sub-segments corresponding to

$${s}_{ue}^{( p )} [ {n}_{1} : {n}_{1} + L - 1 ] and {s}_{gNB}^{( q )} [ {n}_{2} : {n}_{2} + L - 1 ]$$

may be aligned if

$$\{ p , q , {n}_{1} , {n}_{2} \} = arg {max}_{a , b , {m}_{1} , {m}_{2}} ρ [ a , b , {m}_{1} , {m}_{2} , L ] .$$

In another embodiment, the sub-segments corresponding to

$${s}_{ue}^{( p )} [ {n}_{1} : {n}_{1} + L - 1 ] and {s}_{gNB}^{( q )} [ {n}_{2} : {n}_{2} + L - 1 ]$$

may be aligned if

$$\{ p , q , {n}_{1} , {n}_{2} \} = arg {max}_{a , b , {m}_{1} , {m}_{2}} ρ [ a , b , {m}_{1} , {m}_{2} , L ] and {max}_{a , b , {m}_{1} , {m}_{2}} ρ [ a , b , {m}_{1} , {m}_{2} , L ] > {ρ}_{th} ,$$

where ρₜₕ is a pre-determined parameter.

In one embodiment, the sub-segments corresponding to

$${s}_{ue}^{( p )} [ {n}_{1} : {n}_{1} + L - 1 ] and {s}_{gNB}^{( q )} [ {n}_{2} : {n}_{2} + L - 1 ]$$

are aligned if

$$\{ p , q , {n}_{1} , {n}_{2} \} = arg {min}_{a , b , {m}_{1} , {m}_{2}} MSE [ a , b , {m}_{1} , {m}_{2} , L ] .$$

In another embodiment, the sub-segments corresponding to

$${s}_{ue}^{( p )} [ {n}_{1} : {n}_{1} + L - 1 ] and {s}_{gNB}^{( q )} [ {n}_{2} : {n}_{2} + L - 1 ]$$

are aligned if

$$\{ p , q , {n}_{1} , {n}_{2} \} = \text{} arg {min}_{a , b , {m}_{1} , {m}_{2}} \text{} MSE [ a , b , {m}_{1} , {m}_{2} , L ] \text{ } and \text{} {min}_{a , b , {m}_{1} , {m}_{2}} MSE [ a , b , {m}_{1} , {m}_{2} , L ] < {MSE}_{th} ,$$

where MSEₜₕ is a pre-determined parameter.

In another embodiment, if the sub-segments corresponding to

$${s}_{ue}^{( p )} [ {n}_{1} : {n}_{1} + L - 1 ] and {s}_{gNB}^{( q )} [ {n}_{2} : {n}_{2} + L - 1 ]$$

are aligned, then the subsequent part of the same sub-segment is also aligned to reduce the complexity. For instance, if the sub-segments corresponding to

$${s}_{ue}^{( p )} [ {n}_{1} : {n}_{1} + L - 1 ] and {s}_{gNB}^{( q )} [ {n}_{2} : {n}_{2} + L - 1 ]$$

are aligned, then the sub-segments corresponding to

$${s}_{ue}^{( p )} [ {n}_{1} + L - 1 : {n}_{1} + {L}^{′} - 1 ] and {s}_{gNB}^{( q )} [ {n}_{2} + L - 1 : {n}_{2} + {L}^{′} - 1 ]$$

are also aligned, where

$${L}^{′} \leq min \{ {L}_{ue}^{( p )} - {n}_{1} , {L}_{gNB}^{( q )} - {n}_{2} \}$$

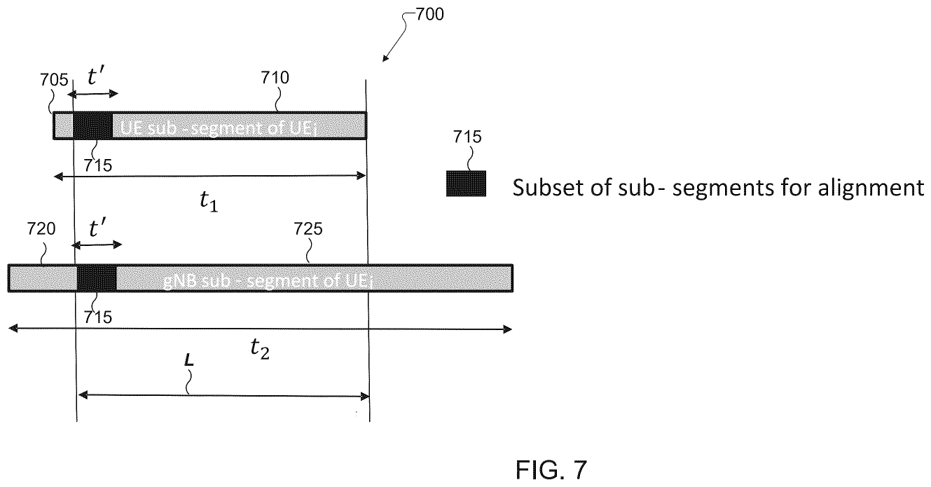

is a parameter. Thus, the alignment may be accelerated by using only a subset of sub-segments from both the UE and gNB logs. The accelerated alignment is illustrated further in detail with reference to FIG. 7.

In one embodiment, L′ may be a function of the periodicity of the selected metric. For instance, a small periodicity implies a small L′. In another embodiment, L′ may be a function of the total length of the sub-segment. For instance, a large sub-segment implies a large L′. In another embodiment, L′ may be a function of the computational resource available for the data preparation. For instance, a large computational resource implies a small L′. In another embodiment, L′ may be a function of the expected reliability of the alignment. For instance, a higher expectation on the reliability implies a smaller L′. In another embodiment, L′ may be determined by a combination of the aforementioned factors.

The aligned sub-segment may have different durations. In one embodiment, if the number of entries of the aligned sequences is smaller than some threshold, then the aligned sequences may not be used for constructing AI/ML dataset for offline training. In another embodiment, if the time duration corresponding to the aligned sequences is smaller than a threshold, then the corresponding sub-segment may be excluded from the AI/ML dataset.

Given the aforementioned approach to align a gNB log with a single UE, alignment between gNB logs collected at multiple cells and UE logs collected by different UEs may be achieved as well. That is, since each of the UEs and gNBs has its own clock as well as the GPS time, aligned logs can be constructed based on these clocks and GPS times. In one embodiment, logs of each UE may be aligned with a single gNB log at first. Then, the UE logs may be mutually aligned given the internal system time of the gNB. In another embodiment, UE logs of multiple UE may be aligned with gNB logs collected from multiple cells at first. Then, the UE logs may be aligned by GPS time available in every UE log. Finally, UE logs from different UEs may be aligned with gNB logs collected in multiple cells. The aligned logs may be used for multi-cell operations including, but not limited to, inter-cell interference mitigation or joint transmission.

At step 625, the AI/ML model is trained offline based on the aligned UE and gNB segments. In one embodiment, the aligned UE logs in a single cell may be used to train the AI/ML model for multi-UE (MU) operation including, but not limited to, MU-MIMO pairing or MU-MIMO precoding.

Although FIG. 6 illustrates one example of a method 600 of data preparation for offline training of the AI/ML model in cellular systems, various changes may be made to FIG. 6. For example, while shown as a series of steps, various steps in FIG. 6 could overlap or occur any number of times. In another example, steps may be omitted or replaced by other steps.

FIG. 7 illustrates an accelerated alignment 700 of a UE log and a gNB log according to embodiments of the present disclosure. The UE and gNB logs have been segmented into a UE segment 705 and a gNB segment 720, which are continuous and have relatively long durations t₁ and t₂, respectively. The UE and gNB segments 705 and 720 are then further segmented into a UE sub-segment 710 and a gNB sub-segment 725 each having time duration (length) L, which is still relatively long. For aligning the UE and gNB logs, rather than computing the entire UE and gNB sub-segments 710 and 725, only portions 715 of the sub-segments 705 and 710 having duration t′ may be computed. If the computation indicates that one or more conditions for alignment (as discussed with reference to FIG. 6) are satisfied, the network device determines that the portions 715 are aligned. Further, based on the determination that the portions 715 are aligned, the network device determines that the entirety of the UE sub-segment 710 and the gNB sub-segment 725 are also aligned. Thus, the alignment of UE and gNB logs is significantly accelerated by using only portions 715 of the UE and gNB sub-segments 710 and 725. The length of the portions for alignment may be selected based on the requirement of the accuracy and the limit on computational complexity in accordance with a given application as previously discussed with reference to FIG. 6.

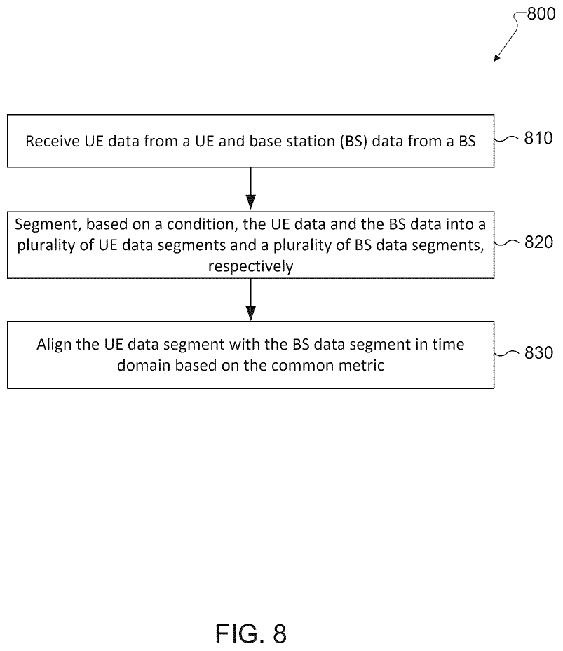

FIG. 8 illustrates an example flow chart for a method 800 of data preparation for AI/ML model training in cellular systems according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of data preparation could be used without departing from the scope of this disclosure.

As illustrated in FIG. 8, the method 800 begins at step 810. At step 810, a network device (e.g., without limitation, a network server 132 of FIGS. 1 and 4) receives UE data from a UE and base station (BS) data from a BS.

At step 820, the network device segments, based on a condition, the UE data and the BS data into a plurality of UE data segments and a plurality of BS data segments, respectively. In one embodiment, segmenting the UE data based on the condition comprises: (i) identifying portions of the UE data as continuous based on at least one of: a largest time gap between two occurrences of the common metric in a same segment being smaller than a threshold; time duration of each segment being larger than a threshold; or a smallest time gap between two occurrences of the common metric in different segments being larger than a threshold; and (ii) including the identified portions in the same UE data segment.

At step 830, the network device aligns the UE data segment with the BS data segment in time domain based on the common metric. In one embodiment, aligning the UE data segment with the BS data segment comprises: identifying, in the UE data segment and the BS data segment, a UE data sub-segment and a BS data sub-segment; and when the common metric is a numeric metric, aligning the UE data sub-segment with the BS data sub-segment based on a determination that correlation of the numeric metric between the UE data sub-segment and the BS data sub-segment exceeds a threshold or a mean squared error of the numeric metric between the UE data sub-segment with the BS data sub-segment is lower than a threshold. In another embodiment, aligning the UE data segment with the BS data segment comprises: identifying, in the UE data segment and the BS data segment, a UE data sub-segment and a BS data sub-segment; and when the common metric is a non-numeric metric, aligning the UE data sub-segment with the BS data sub-segment based on a determination that sequences of the non-numeric metric at both the UE data sub-segment and the BS data sub-segment the same. In one embodiment, aligning the UE data segment with the BS data segment comprises: identifying, in the UE data segment and the BS data segment, a UE data sub-segment and a BS data sub-segment; and aligning the UE data sub-segment and the BS data sub-segment using a portion of each of the UE data sub-segment and the BS data sub-segment, where length of the portion is selected based on a level of accuracy and a limit on computational complexity.

In one embodiment, the method 800 further includes training an AI or ML model offline based on aligned segments. When the UE comprises a single UE and the BS comprises a single BS, the AI or ML model is trained for single-UE operation based on the alignment of the UE data segment and the BS data segment. When the UE comprises multiple UEs and the BS comprises a single BS, the AI or ML model is trained for multi-UE operation based on the alignment of the UE data segment and the BS data segment. When the UE comprises multiple UEs and the BS comprises multiple BSs, the AI or ML model is trained for multi-cell operation based on alignments of UE data segments across multiple cells.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A method of preparing data, the method comprising:
receiving, by a network device, user equipment (UE) data from a UE and base station (BS) data from a BS;
segmenting, based on a condition, the UE data and the BS data into a plurality of UE data segments and a plurality of BS data segments, respectively;
identifying a common metric used in both a UE data segment of the plurality of UE data segments and a BS data segment of the plurality of BS data segments; and
aligning the UE data segment with the BS data segment in time domain based on the common metric.

2. The method of claim 1, further comprising:
training an artificial intelligence (AI) or machine learning (ML) model offline based on aligned segments.

3. The method of claim 1, wherein segmenting the UE data based on the condition further comprises:
identifying portions of the UE data as continuous based on at least one of:
a largest time gap between two occurrences of the common metric in a same segment being smaller than a threshold;
time duration of each segment being larger than a threshold; or
a smallest time gap between two occurrences of the common metric in different segments being larger than a threshold; and
including the identified portions in the same UE data segment.

4. The method of claim 1, wherein aligning the UE data segment with the BS data segment further comprises:
identifying, in the UE data segment and the BS data segment, a UE data sub-segment and a BS data sub-segment; and
when the common metric is a numeric metric, aligning the UE data sub-segment with the BS data sub-segment based on a determination that correlation of the numeric metric between the UE data sub-segment and the BS data sub-segment exceeds a threshold or a mean squared error of the numeric metric between the UE data sub-segment with the BS data sub-segment is lower than a threshold.

5. The method of claim 1, wherein aligning the UE data segment with the BS data segment further comprises:
identifying, in the UE data segment and the BS data segment, a UE data sub-segment and a BS data sub-segment; and
when the common metric is a non-numeric metric, aligning the UE data sub-segment with the BS data sub-segment based on a determination that sequences of the non-numeric metric at both the UE data sub-segment and the BS data sub-segment are the same.

6. The method of claim 1, wherein aligning the UE data segment with the BS data segment further comprises:
identifying, in the UE data segment and the BS data segment, a UE data sub-segment and a BS data sub-segment; and
aligning the UE data sub-segment and the BS data sub-segment using a portion of each of the UE data sub-segment and the BS data sub-segment,
wherein a length of the portion is selected based on a level of accuracy and a limit on computational complexity.

7. The method of claim 1, further comprising:
training an artificial intelligence (AI) or machine learning (ML) model offline based on aligned segments, wherein:
when the UE comprises a single UE and the BS comprises a single BS, the AI or ML model is trained for single-UE operation based on the alignment of the UE data segment and the BS data segment,
when the UE comprises multiple UEs and the BS comprises a single BS, the AI or ML model is trained for multi-UE operation based on the alignment of the UE data segment and the BS data segment, or
when the UE comprises multiple UEs and the BS comprises multiple BSs, the AI or ML model is trained for multi-cell operation based on alignments of UE data segments across multiple cells.

8. A network device comprising:
memory configured to receive user equipment (UE) data from a UE and base station (BS) data from a BS; and
a processor operably coupled to the memory, the processor configured to:
segment, based on a condition, the UE data and the BS data into a plurality of UE data segments and a plurality of BS data segments, respectively;
identify a common metric used in both a UE data segment of the plurality of UE data segments and a BS data segment of the plurality of BS data segments; and
align the UE data segment with the BS data segment in time domain based on the common metric.

9. The network device of claim 8, further configured to:
train an artificial intelligence (AI) or machine learning (ML) model offline based on aligned segments.

10. The network device of claim 8, wherein to segment the UE data based on the condition, the processor is further configured to:
identify portions of the UE data as continuous based on at least one of:
a largest time gap between two occurrences of the common metric in a same segment being smaller than a threshold;
time duration of each segment being larger than a threshold; or
a smallest time gap between two occurrences of the common metric in different segments being larger than a threshold; and
include the identified portions in the same UE data segment.

11. The network device of claim 8, wherein to align the UE data segment with the BS data segments, the processor is further configured to:
identify, in the UE data segment and the BS data segment, a UE data sub-segment and a BS data sub-segment; and
when the common metric is a numeric metric, align the UE data sub-segment with the BS data sub-segment based on a determination that correlation of the numeric metric between the UE data sub-segment and the BS data sub-segment exceeds a threshold or a mean squared error of the numeric metric between the UE data sub-segment with the BS data sub-segment is lower than a threshold.

12. The network device of claim 8, wherein to align the UE data segment with the BS data segment, the processor is further configured to:
identify, in the UE data segment and the BS data segment, a UE data sub-segment and a BS data sub-segment; and
when the common metric is a non-numeric metric, align the UE data sub-segment with the BS data sub-segment based on a determination that sequences of the non-numeric metric at both the UE data sub-segment and the BS data sub-segment are the same.

13. The network device of claim 8, wherein to align the UE data segment with the BS data segment, the processor is further configured to:
identify, in the UE data segment and the BS data segment, a UE data sub-segment and a BS data sub-segment; and
align the UE data sub-segment and the BS data sub-segment using a portion of each of the UE data sub-segment and the BS data sub-segment,
wherein a length of the portion is selected based on a level of accuracy and a limit on computational complexity.

14. The network device of claim 8, wherein the processor is further configured to:
train an artificial intelligence (AI) or machine learning (ML) model offline based on aligned segments, wherein:
when the UE comprises a single UE and the BS comprises a single BS, the AI or ML model is trained for single-UE operation based on the alignment of the UE data segment and the BS data segment,
when the UE comprises multiple UEs and the BS comprises a single BS, the AI or ML model is trained for multi-UE operation based on the alignment of the UE data segment and the BS data segment, or
when the UE comprises multiple UEs and the BS comprises multiple BSs, the AI or ML model is trained for multi-cell operation based on alignments of UE data segments across multiple cells.

15. A non-transitory computer readable medium embodying a computer program, the computer program comprising program code that, when executed by a processor of a network device, causes the network device to:
receive user equipment (UE) data from a UE and base station (BS) data from a BS;
segment, based on a condition, the UE data and the BS data into a plurality of UE data segments and a plurality of BS data segments, respectively;
identify a common metric used in both a UE data segment of the plurality of UE data segments and a BS data segment of the plurality of BS data segments; and
align the UE data segment with the BS data segment in time domain based on the common metric.

16. The non-transitory computer readable medium of claim 15, further comprising program code that, when executed by the processor of the network device, causes the network device to train an artificial intelligence (AI) or machine learning (ML) model offline based on aligned segments.

17. The non-transitory computer readable medium of claim 15, wherein the program code that, when executed by the processor of the network device, causes the network device to segment the UE data based on the condition comprises program code that, when executed by the processor of the network device, causes the network device to:
identify portions of the UE data as continuous based on at least one of:
a largest time gap between two occurrences of the common metric in a same segment being smaller than a threshold;
time duration of each segment being larger than a threshold; or
a smallest time gap between two occurrences of the common metric in different segments being larger than a threshold; and
include the identified portions in the same UE data segment.

18. The non-transitory computer readable medium of claim 15, wherein the program code that, when executed by the processor of the network device, causes the network device to align the UE data segment with the BS data segment comprises program code that, when executed by the processor of the network device, causes the network device to:
identify, in the UE data segment and the BS data segment, a UE data sub-segment and a BS data sub-segment; and
when the common metric is a numeric metric, align the UE data sub-segment with the BS data sub-segment based on a determination that correlation of the numeric metric between the UE data sub-segment and the BS data sub-segment exceeds a threshold or a mean squared error of the numeric metric between the UE data sub-segment with the BS data sub-segment is lower than a threshold.

19. The non-transitory computer readable medium of claim 15, wherein the program code that, when executed by the processor of the network device, causes the network device to align the UE data segment with the BS data segment comprises program code that, when executed by the processor of the network device, causes the network device to:
identify, in the UE data segment and the BS data segment, a UE data sub-segment and a BS data sub-segment; and
when the common metric is a non-numeric metric, align the UE data sub-segment with the BS data sub-segment based on a determination that sequences of the non-numeric metric at both the UE data sub-segment and the BS data sub-segment are the same.

20. The non-transitory computer readable medium of claim 15, wherein the program code that, when executed by the processor of the network device, causes the network device to align the UE data segment with the BS data segment comprises program code that, when executed by the processor of the network device, causes the network device to:
identify, in the UE data segment and the BS data segment, a UE data sub-segment and a BS data sub-segment; and
align the UE data sub-segment and the BS data sub-segment using a portion of each of the UE data sub-segment and the BS data sub-segment,
wherein a length of the portion is selected based on a level of accuracy and a limit on computational complexity.
